(19) United States
(12) Patent Application Publication
(10) Pub. No.: US 2015/0223160 A1
(43) Pub. Date: Aug. 6, 2015

(54) DIRECTING NETWORK ASSOCIATION OF A WIRELESS CLIENT

(71) Applicant: QUALCOMM Incorporated, San Diego, CA (US)

(72) Inventors: Sai Yiu Duncan Ho, San Diego, CA (US); Vishwanatha Sastry Katariki, San Deigo, CA (US); Peerapol Tinnakornsrisuphap, San Diego, CA (US); Brian Michael Buesker, San Diego, CA (US)

(21) Appl. No.: 14/490,389

(22) Filed: Sep. 18, 2014

Related U.S. Application Data
(60) Provisional application No. 61/934,559, filed on Jan. 31, 2014.

(51) Int. Cl. H04W 48/20; H04W 72/04

(52) U.S. Cl. CPC H04W 48/20; H04W 72/0453; H04W 84/12

(57) ABSTRACT

A wireless network may have a plurality of access points (APs). A network device may select a first AP from the plurality of APs for a wireless client device to access the wireless network. The first AP may be selected based at least in part on network performance between the wireless client device and the network device. The network device may cause the wireless client device to associate with the first AP.

### RELATED APPLICATIONS

This application claims the priority benefit of U.S. Provisional Application Ser. No. 61/934,559 filed Jan. 31, 2014

### FIELD OF THE DISCLOSURE

Embodiments of the present disclosure generally relate to the field of communication systems, and, more particularly, to association of a wireless client device with an access point of a wireless network.

### BACKGROUND

In a wireless network (e.g., a wireless local area network, or WLAN), a wireless client device (e.g., a wireless station, or STA) may establish a wireless association (i.e., “associate”) with a wireless access point (AP). However, a wireless network may include two or more APs. Often, a router is connected to a cable modem or digital subscriber line (DSL) modem to provide access to a broadband network. The router may provide broadband network access for one or more APs. Additionally, range extenders (REs) can be used to extend coverage throughout the wireless network. An RE may operate similar to an AP by receiving, buffering and then relaying data to and from another AP. In some wireless networks, an AP or RE may operate in a 2.4 GHz frequency band, a 5 GHz frequency band, or in both the 2.4 GHz frequency band and the 5 GHz frequency band.

Traditionally, the wireless client device may select an AP and a frequency band using an AP selection algorithm at the wireless client device. However, various network conditions may be relevant to selecting an AP to optimize performance characteristics (e.g., throughput, etc.). The wireless client device may not be aware of network conditions during selection of an AP.

### SUMMARY

Various embodiments are disclosed in which a network device of a wireless network may select an AP for a wireless client device and cause the wireless client device to associate with the selected AP.

In one embodiment, a method comprises selecting, at a network device, a first access point (AP) from a plurality of APs of a wireless network for a wireless client device to access the wireless network, the first AP selected based at least in part on network performance between the wireless client device and the network device; and causing the wireless client device to associate with the first AP.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system diagram of a wireless network.

FIG. 2 depicts another example system diagram in which a wireless network includes range extenders.

FIG. 3 illustrates a flow diagram of example operations to implement a re-association of a wireless client device from a first AP to a second AP of a wireless network.

FIG. 4 depicts an example system diagram illustrating a wireless client device associating with a first AP of a hybrid network based on backhaul conditions.

FIG. 5 is an example block diagram of an electronic device capable of implementing various embodiments in accordance with this disclosure.

### DESCRIPTION OF EMBODIMENT(S)

The description that follows includes example systems, methods, techniques, instruction sequences and computer program products that embody techniques of the present disclosure. However, it is noted that the described embodiments may be practiced without these specific details. For instance, although examples refer to wireless systems having defined frequency bands in compliance with IEEE 802.11 specifications, other wireless, wired, or hybrid systems may be used. In other instances, well-known instruction instances, protocols, structures and techniques have not been shown in detail in order not to obfuscate the description.

A wireless client device accesses resources on a network by communicatively coupling (e.g., associating, registering, or establishing a wireless association in accordance with an association protocol) with an AP of a wireless network. Typically, a wireless client device may be configured to select an AP from a plurality of APs based upon signal strength. However, a different AP may be a better choice for the wireless client device due to backhaul performance, loading, network topology, user movement, or other conditions. Furthermore, various APs and the wireless client device may have different hardware capabilities (e.g., 2.4 GHz and/or 5 GHz support, dual band single radio, dual band dual concurrent radios (DBDC), etc.) that may affect overall performance.

A network device may have access to more information regarding backhaul conditions or other available APs than a wireless client device. For example, a central access point or router may provide connectivity for a plurality of APs, including a first AP and a second AP. The network device may select a particular AP for the wireless client device based on a variety of factors including, but not limited to, backhaul capacity, wireless resource utilization, application performance, or the like. The wireless client device may not have as much network or connectivity information as the network device for making AP selections. As a result, the network device may cause the wireless client device to associate with the selected AP by managing configurations of one or more APs. For example, the network device may cause a first AP to block traffic to/from the wireless client device so that the wireless client device connects to the selected AP. As a result of the first AP blocking traffic for the wireless client device, the wireless client device may establish an association with the selected AP.

In addition to, or alternatively from, selecting an AP, the network device may also select a frequency band. For example, the network device may select between a 2.4 GHz or 5 GHz frequency band, depending on which of those frequency bands provides the best or most improved performance (e.g. maximum bandwidth, highest throughput, highest bursting, lowest latency, lowest errors, lowest jitter, etc.) from the available frequencies bands for communication with the wireless client device. However, the network device may utilize any number of frequency bands available to be utilized without limitation. In one embodiment, the network device may also select a communication channel within the selected frequency band. The network device may manage the configurations of the APs to control the wireless environment such that the wireless client device independently performs a client-side AP selection that effectively results in a connection to the AP which the network device has selected. The network device may also manage the configurations of the APs to improve overall performance of the network or system. For example, a first wireless client device may be transitioned from a first AP to a second AP to improve performance (e.g., throughput, bandwidth, latency, errors, jitter, bursting, etc.) through the network. In one embodiment, the change may be implemented even if the performance for the first wireless client is decreased for the benefit of the entire network.

A wireless network in a home, apartment, or other area may include one or more APs that provide access to a local network. A network device, independent and separate from the applicable APs and wireless client devices, such as a central access point (CAP) or router, may provide access to a broadband network. For example, the network device can couple to the broadband network through a cable, a fiber optic, a powerline, or DSL network connection. Wireless client devices in the wireless network can establish a link to an AP to access the broadband network via the network device. However, the AP may not provide uniform coverage. As wireless signals propagate further from the AP, wireless signal strength decreases. In areas of weak signal strength, a station may not be able to establish a link to the AP. In different circumstances, even if a link can be established, the weak signal strength present at the station may not support high data throughput rates or may result in unsatisfactory latency or errors.

In this disclosure, the term AP refers to any device that provides wireless access to a network, including access points and range extenders (RE). An RE can extend wireless network coverage by operating as an AP between the wireless client device and another AP. To improve connectivity and coverage, an AP (or RE) can be configured as a dual band, dual concurrent (DBDC) wireless device. A DBDC device can include two transceivers and can operate on two different frequency bands independently and simultaneously. For example, a first transceiver can operate in the 2.4 GHz frequency band and a second transceiver can operate in the 5 GHz frequency band. The two transceivers can be linked within the DBDC device such that data can be communicated between the transceivers.

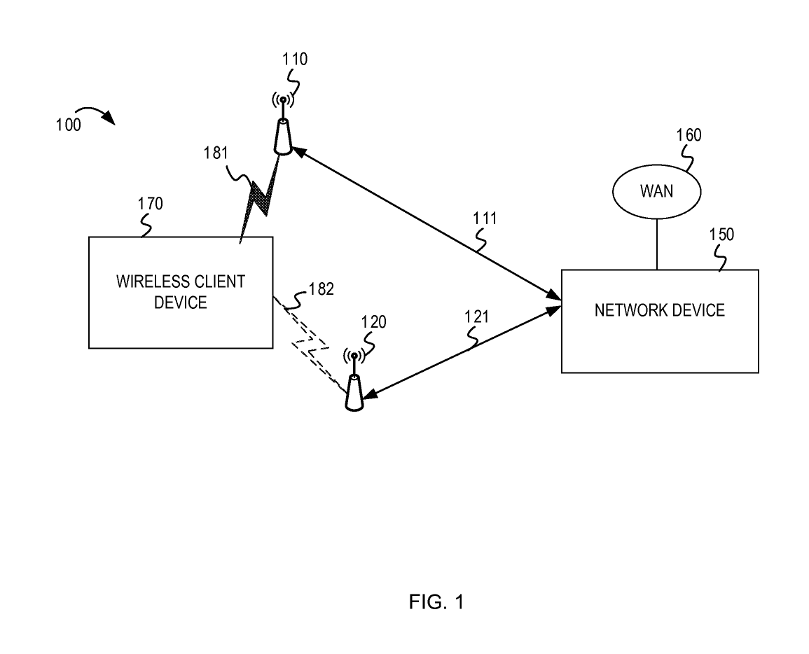

FIG. 1 depicts an example system diagram that includes a wireless network 100. The wireless network 100 may include any number of devices, components, and units and may alternatively be referred to as a system. In one embodiment, the wireless network 100 includes a wireless client device 170 (e.g., a laptop, a computer, a sensor, a camera, a thermostat, a mobile station, a wireless device, a smartphone, etc.), a first AP 110, and a second AP 120. The first AP 110 may have a backhaul connection 111 to a network device 150 (e.g., central access point or router). In one embodiment, the network device 150 is independent and separate from the first AP 110 and the second AP 120.

In another embodiment, the first AP 110 may be collocated with the network device 150 or may be part of the same apparatus. The second AP 120 may also have a backhaul connection 121 to the network device 150. The backhaul connections 111, 121 may be wired or wireless. The network device 150 may be communicatively coupled to a wide area network (WAN) 160 or one or more other networks.

The network device 150 may be configured to enhance performance of the wireless client device 170. In one embodiment, the network device 150 may sense, determine, or otherwise be aware of conditions in which the wireless client device 170 would be better served in the wireless network 100 by having the wireless client device 170 associate with the first AP 110 rather than the second AP 120. The conditions may be current conditions, historical conditions, or future conditions (e.g., predicted conditions). As a result, the network device 150 may be able to make decisions that are more comprehensive than if made by other devices of the wireless network 100, such as the wireless client device 170. As described herein, terms such as wireless link, wireless connection, wireless association, or the like, may be used interchangeably to refer to a wireless communication relationship between two devices in the wireless network 100.

In one embodiment, the first and second APs 110, 120 may provide information to the network device 150 that the network device 150 may use to select an AP that provides the best available network performance for the wireless client device 170. For example, the APs 110, 120 may provide information about network traffic flow, backhaul network conditions, loading, frequency bands, or network bandwidth availability. The APs 110, 120 may also provide information regarding wireless capacity to serve the wireless client device 170, the number of wireless client devices associated with each AP and/or signal strength (such as received signal strength indicator, RSSI) of signals detected from the wireless client device 170. In other embodiments, any number of other intelligent network devices (not shown) within the wireless network 100 may provide information to the network device 150 that is utilized to make the

In some embodiments, the APs 110, 120 or the network device 150 may obtain information about application throughput, such as throughput capability from each AP 110, 120 to an application server (such as a resource via the WAN 160). For example, the first AP 110 may offer greater application throughput (via the backhaul connection 111 to the network device 150) to the wireless client device 170 than the application throughput offered by the second AP 120 (via the backhaul connection 121 to the network device 150). The network device 150 may utilize any of the example types of information described above, or other factors, to select an AP for the wireless client device 170 to access the wireless network 100.

In the example in FIG. 1, the network device 150 may select the first AP 110 for the wireless client device 170 to access the wireless network 100. For example, the first AP 110 may provide better network performance (via a first potential wireless association 181) to the wireless client device 170 than the second AP 120 (via a second potential wireless association 182). As an example, the first AP 110 may have less wireless utilization, a different frequency band, less backhaul latency, or the like. As another example, first AP 110 may provide a 5 GHz frequency band for communication with the wireless client device 170 which may be better suited for the type of traffic for the wireless client device 170 than a 2.4 GHz frequency band used by the second AP 120. The network device 150 may manage which wireless client devices associate with the first AP 110 and second AP 120 based on the type of traffic used by each wireless client device. As an example, multimedia or low latency communication may be directed to the first AP 110, while best effort latency or reliable delivery communication may be directed to the second AP 120.

The network device 150 may also determine compatibility regarding wireless access technologies utilized by the wireless client device 170. Different wireless access technologies might be defined in standard specifications. The wireless access technologies may have different physical communication rates or protocols. The first AP 110 may utilize a first wireless access technology utilized by a first set of wireless client devices and the second AP 120 may utilize a second wireless access technology compatible with a second set of wireless client devices. If a wireless client device supports both the first wireless access technology and the second wireless access technology, a selection of the AP may be based on physical communication rates available from the wireless access technologies. The network device 150 may direct the wireless client device 170 to the second AP 120 associated with a faster physical communication rate than the first AP 110.

The network device 150 may command or direct (or “steer”) the wireless client device 170 to utilize the first AP 110 rather than the second AP 120. In addition to steering the wireless client device 170 to a particular AP, the network device 150 may steer the wireless client device 170 to utilize a particular frequency band (e.g., 2.4 GHz or 5 GHz) and channel. The network device 150 may be able to receive, determine, or analyze more information about the communication within the wireless network 100 than individual devices, such as the wireless client device 170.

Because the wireless client device 170 may be a traditional wireless device in compliance with legacy wireless standards, the network device 150 may utilize configurations of the first AP 110 and/or second AP 120 to cause the wireless client device 170 to associate with the selected AP and the desired frequency band. For example, the network device 150 may send a message to the second AP 120 to instruct the second AP 120 to block traffic to or from the wireless client device 170. Blocking traffic may include discarding packets or may include sending a rejection or unavailability notice to the wireless client device 170. In one embodiment, the second AP 120 may receive an instruction from the network device 150 to block traffic to or from the wireless client device 170. In one embodiment, in response to receiving the instruction, the second AP 120 may prevent a wireless association with the wireless client device 170. For example, the second AP 120 may add the wireless client device 170 to a blacklist for the second AP 120. In another embodiment, the second AP 120 may receive a command from the network device 150 to cease communication with the wireless client device 170, and thus force the wireless client device 170 to re-connect via another AP, such as the first AP 110.

After being blocked by the second AP 120, the wireless client device 170 may autonomously perform an access point selection to identify a new AP to associate with or connect to. The wireless client device 170 may then select the first AP 110 and perform wireless association. Therefore, while the network device 150 may not manage the wireless configuration of the wireless client device 170, the network device 150 may control the configurations of the APs 110, 120 to cause the wireless client device 170 to associate with the selected first AP 110 and/or frequency band.

In one embodiment, the network device 150 (or first AP 110, or second AP 120) may monitor behavior of the wireless client device 170 in response to being blocked by the second AP 120. An error condition could result in the wireless client device 170 if the wireless client device 170 repeatedly attempts to associate with the second AP 120 despite being blocked by the second AP 120. The wireless client device 170 may become locked out while trying to associate with the second AP 120 and the second AP 120 is instructed to block association by the wireless client device 170. For example, user input may be received by the wireless client device 170 to connect to or remain connected to the second AP 120, even if the second AP 120 is instructed by the network device 150 to block traffic for the wireless client device 170. Upon detecting that the wireless client device 170 is repeatedly attempting to associate with the second AP 120 despite efforts to cause the wireless client device 170 to associate with the first AP 110, the network device 150 may cause the second AP 120 to allow the wireless association (e.g., disregarding the previous selection of the first AP 110). For example, the network device 150 may allow the wireless client device 170 to connect to the second AP 120 to avoid putting the wireless client device 170 into an unusable state. The wireless network 100 or the network device 150 may also learn the behavior of the wireless client device 170 over time to dynamically adjust the criteria, rules, policies, or settings utilized to select or reselect the corresponding AP for the wireless client device 170. For example, historical selections, user overrides, time of day selections, and other criteria may be utilized to determine how and when the AP selections are made for the wireless client device 170.

In another embodiment, the wireless network 100 or the network device 150 may apply different rules to different wireless clients based on the service provider associated with the wireless client device vendor (e.g., chipset vendor), or both. In one embodiment, a minimum time may be utilized between redirection to available APs for the wireless client device 170 that may experience errors or other problems in response to being redirected too frequently. The network device 150 may also prevent redirection from the second AP 120 to the first AP 110 in response to the wireless client device 170 communicating real-time traffic to prevent or avoid service interruptions. In one example, if the wireless client device 170 is being redirected from the second AP 120 to the first AP 110 because the signal from the second AP 120 is becoming weak, the first AP 110 should not blacklist or otherwise prevent a connection from the wireless client device 170. The wireless network 100 and the network device 150 may utilize any number of safety mechanisms to ensure that the wireless client device 170 is able to communicate with one of the access points 110, 120 even if the conditions are not optimal based on the rules, criteria, performance, information, and user preferences specified.

In another embodiment, the wireless client device 170 may be steered to associate with the first AP 110 to perform load balancing on the wireless network 100. For example, multiple wireless client devices (not shown) may communicate with the first AP 110 and the second AP 120. The wireless client device 170 may be transferred to the first AP 110 based on any number of factors and conditions that may affect load balancing including, newly connected devices, intensity of communication between wireless client devices with the APs 110, 120 (e.g., bandwidth, bursting, types of traffic, etc.), assigned priorities of the wireless client devices, and so forth. For example, an administrator may utilize a user interface or program that controls operations of the network device 150 to assign priorities for communication from each of the wireless client devices. The wireless client devices with the highest priority are assigned to the respective AP that is likely to give the higher priority devices the best communication performance and throughput.

In one example, one or more client device associations may be changed at a time to improve the overall performance of the wireless network 100. For example, the network device 150 may have the wireless client device 170 transition from the first AP 110 to the second AP 120 to improve overall throughput through the wireless network 100. Changes may be implemented even if the performance of the individual wireless client device 170 decreases (based on the implemented change) for the benefit of the system, wireless network 100 or higher priority wireless client devices. As a result, the overall performance of the wireless network 100 may be prioritized over the performance of individual devices, such as the wireless client device 170.

In another embodiment, a network device outside the wireless network 100 may be utilized to select the AP with which the wireless client device 170 should associate. For example, an intelligent network device associated with an external network or a communication service provider (e.g., edge device, server, packet analyzer, switches, bridges, hubs, repeaters, network nodes, etc.) may utilize additional information, such as packet routing, types of communication, destination devices, or so forth to select the first AP 110 or the second AP 120. For example, the network device 150 may have information regarding data routing to the first AP 110 and the second AP 120 that may be utilized to select or reselect the corresponding AP for the wireless client device 170. For example, the network device 150 may balance traffic among the first AP 110 and the second AP 120 to maximize overall performance and throughput through the wireless network 100.

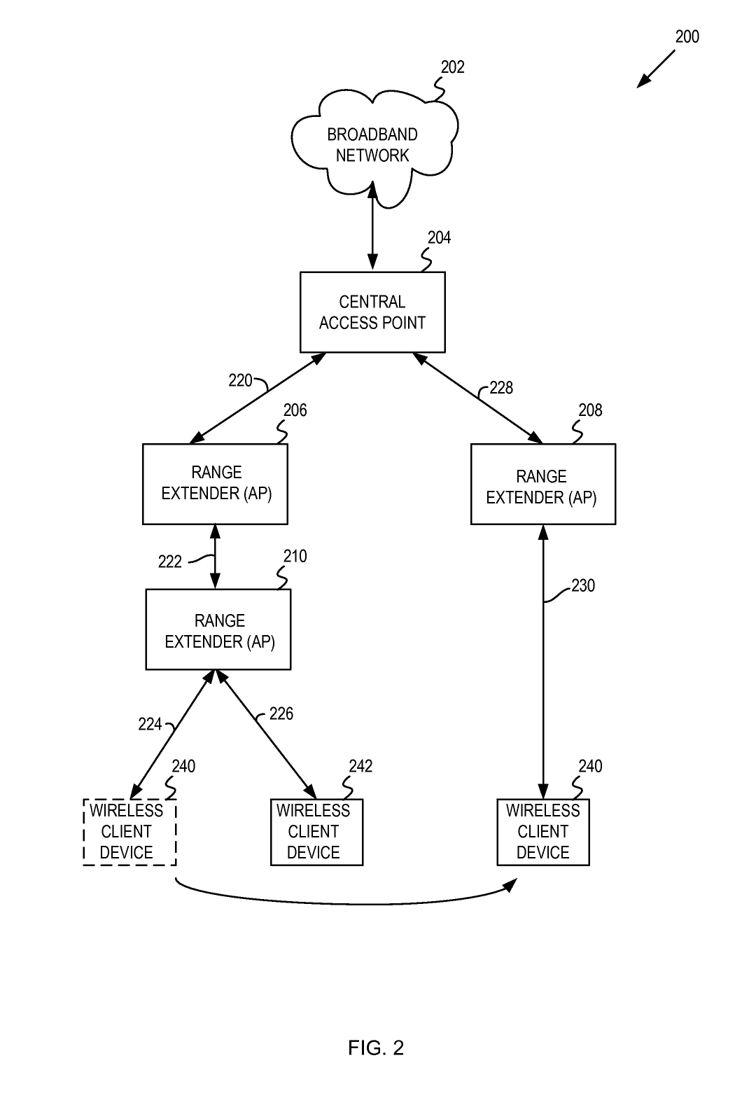

FIG. 2 is an example system diagram of a wireless network 200. This example wireless network 200 shows network topology including a central access point (CAP) 204 (as a network device) and REs 206-210. In the example wireless network 200, the CAP 204 is a DBDC capable device and is communicatively coupled (linked) to a broadband network 202. The CAP 204 may include routing connections or capability between a local area wireless network (not shown) and the broadband network 202.

The wireless network 200 can include one or more APs. In this example, wireless network 200 includes REs that are acting as APs and extending the range of the CAP 204. Similar to the CAP 204, each RE is also DBDC capable. The REs 206-210 can be positioned throughout a desired coverage area of the wireless network 200. As shown in FIG. 2, RE 206 is coupled to the CAP 204 through link 220. Similarly, RE 210 is coupled to RE 206 through link 222 and RE 208 is coupled to CAP 204 through link 228. Each link can represent a particular frequency band (2.4 GHz or 5 GHz, for example) and a particular channel within that frequency band that can be used to carry wireless data between two devices.

Since the CAP 204 and the REs 206-210 are DBDC capable, the CAP 204 and the REs 206-210 each include two independent transceivers (not shown). For example, the CAP 204 can transmit and receive data through a first transceiver in either the 2.4 GHz band or 5 GHz band (or both) for link 220. The CAP 204 can transmit and receive data through a second transceiver in the 2.4 GHz band or 5 GHz band (or both) for link 228. The CAP 204 may also be upgraded (e.g., transceiver card) for additional transceivers utilizing developing standards. In one embodiment, the CAP 204 and the REs 206-210 can comply with an IEEE 802.11 specification for wireless data transmissions. In another embodiment, the CAP 204 and the REs 206-210 can comply with other wireless specifications, such as a Zigbee® specification, or a cellular radio specification or any other technically feasible wireless protocol. The link between the CAP 204 and the broadband network 202 can be referred to as a backhaul link. The backhaul link can provide at least a portion of a data pathway to another network (e.g., communication service provider network, Internet, etc.). The backhaul link of the CAP 204 can be a wireless, a wired (such as through an Ethernet or powerline connection), or a hybrid link. For example, the CAP 204 may also instruct a wireless client device (e.g. wireless client device 240) which transceiver of RE 210 to utilize to maximize performance.

In some embodiments, the REs 206-210 can include an internal data link coupling data from a first transceiver to a second transceiver. For example, data can be received through the first transceiver in the 2.4 GHz frequency band and can be transmitted through the second transceiver in the 5 GHz frequency band. The internal data link can provide additional flexibility in determining data pathways in the wireless network 200.

In one example, wireless client device 240 (shown with dashed lines) is coupled to RE 210 through link 224 and wireless client device 242 is coupled to RE 210 through link 226. RE 210 is coupled to RE 206 through link 222. Since RE 210 is DBDC capable, link 224 and link 226 can use the same frequency band and channel assigned to link 222, or alternatively, link 224 and 226 can use a different frequency band compared to link 222. For example, link 222 can be configured to operate in the 2.4 GHz frequency band through a first transceiver in RE 210. Link 224 can be configured to operate in the 5 GHz frequency band through a second transceiver in RE 210. Link 226 can be configured to operate in either the 2.4 GHz or the 5 GHz frequency band through either the first or the second transceiver in RE 210. As depicted, link 222 is the backhaul link for RE 210. The other links (link 224 and 226) on RE 210 can be referred to as serving links. In a similar manner, links 224 and 226 can serve other REs or stations. Link 228 can be the backhaul link for RE 208.

The wireless client devices 240-242 in the wireless network 200 can have different application performance criteria based, at least in part, on applications running on each wireless client device. Differing applications can have differing data throughput requirements. For example, wireless client device 240 can be a tablet computer displaying a movie that is being streamed from a content provider, through the broadband network 202. In a first example, a streaming movie can have a data throughput rate of 6 Megabits per second. Wireless client device 242 can be a smart phone currently being used to display web data also from the broadband network 202. Displaying web data can have a data throughput rate of 100 Kilobits per second. The data throughput for the web data may be bursty compared to the data throughput for the streaming movie. In one embodiment, the desired quality of service can be related to the data throughput associated with application traffic. The CAP 204 may select which access point that the wireless client device 240 utilizes by, at least in part, configuring the CAP 204 and the REs 206-210 in the wireless network 200. The CAP 204 can select the desired AP based at least in part on the channel conditions, device configurations and capabilities, and quality of service parameters for the wireless client devices 240-242. The channel conditions can include network loading, congestion and usage of wireless frequencies and channels that are available for use by the CAP 204, the REs 206-210 and the wireless client devices 240-242.

The channel conditions can also include detection of interferers and blockers in and adjacent to the wireless frequencies that can be used for wireless communication. The channel conditions can also include link data throughput rates. Each link within the wireless network 200 can have a different data throughput rate. Data throughput rates can be determined, at least in part, by distance between the devices (CAP 204, REs 206-210 and wireless client devices 240-242) and other devices using the link. Network loading can relate to channel utilization. For example, a channel that is near capacity can be considered a heavily loaded network.

The channel conditions can also include the types of data transmitted through the links of the wireless network 200. For example, communication history may provide information regarding congestion or potential congestion. The type of traffic (e.g., streaming media, intermittent web traffic, application traffic, etc.) may be stored by the CAP 204 for subsequent reference. In one embodiment, the historical trends for the wireless network 200 may be utilized to associate the wireless client devices 240-242 with the REs 208, 210. For example, the CAP 204 may note that the wireless client device 240 is often used to stream media content at night and may steer the wireless client device 240 to associate with the RE 210 to avoid the more congested RE 208.

Channel conditions can also include received signal strength indicator (RSSI) measurements for signals received by REs 206-210 and the CAP 204. For example, a network analysis unit (not shown) of the CAP 204 can determine the channel conditions described above within the wireless network 200. Alternatively, the network analysis unit can collect channel conditions as determined by the CAP 204, the REs 206-210 and the wireless client devices 240-242. In one embodiment, the network analysis unit may obtain RSSI measurements from the REs 206-210 to determine which RE has the strongest signal from the wireless client device 240. The network analysis unit can also determine the frequency capabilities of non-DBDC capable devices. For example the network analysis unit can poll the CAP 204, the REs 206-210 and the wireless client devices 240-242 to determine their respective configurations and capabilities. The network analysis unit may also monitor application traffic associated with the wireless client devices 240-242.

The CAP 204 may select RE 208 for the wireless client device 240 to utilize. For example a network selection unit (not shown) of the CAP 204 may utilize information collected by the network analysis unit to determine which AP (CAP 204 or REs 206-210) will provide better application performance for an application running on wireless client device 240. As an example, the wireless client device 240 may be streaming a multimedia data stream which would perform better via one hop (via RE 208) rather than two hops (via RE 210 and RE 206) between the CAP 204 and the wireless client device 240. As another example, wireless client device 240 may require a 5 GHz link 230 provided by RE 208 for a particular application while wireless client device 242 may have a different application better suited for a 2.4 GHz link 226 provided by RE 210. The selection can be based, at least in part, on a relative importance, assigned priority, or preference of some applications or wireless client devices over others. For example, multimedia streaming applications may be weighted higher for the 5 GHz frequency compared to the 2.4 GHz frequency. In another example, a particular wireless client device can be weighted greater (i.e., assigned priority) with respect to another wireless client device. Wireless client device priority can be used when a particular wireless client device is being used to stream a movie while other wireless client devices are being used for web browsing. In this manner, more or less importance can be assigned to channel conditions, device capabilities, and desired QoS to determine the configuration parameters for devices in the network 200. The available frequency bands available to the wireless client device may also be utilized to make selections and perform corresponding configurations.

Once the CAP 204 has selected an AP for the wireless client device 240, the CAP 204 may cause the wireless client device 240 to associate with the selected AP. For example, the CAP 204 may select RE 208 rather than RE 210 for the wireless client device 240. A network configuration unit (not shown) of the CAP 204 may manage configurations of the REs to cause the wireless client device 240 to associate with the selected RE 208. For example, the CAP 204 may instruct the RE 210 to blacklist, reject, or block traffic from the wireless client device 240. The wireless client device 240 may then select RE 208. For example, the wireless client device 240 may have a stronger signal from RE 210 than RE 208. But upon being rejected by RE 210, the wireless client device 240 may have a next strongest signal from RE 208.

The CAP 204 may allow any number of overrides to be provided for connecting to one or more APs or REs. For example, a user may provide a pin, password, or override code through one of the wireless client devices 240-242. If one of the wireless client devices 240-242 is unable (or unwilling) to transition to a selected AP or RE, the CAP 204 may allow access to a non-selected AP or RE to prevent a scenario where communication service is not offered even though available (even if not optimal). The CAP 204 may include a memory or database for storing historical information associated with the wireless client devices 240-242 to best transition the wireless client devices 240-242 to the APs and REs that offer optimal service or service that is optimal for the overall system or network. As a result, the CAP 204 may dynamically adjust over time to the changing utilization, parameters, and factors that may affect the CAP 204. The CAP 204 may also include a time period to prevent transition between APs or REs too frequently. The CAP 204 may also prevent redirection of one of the wireless client devices 240-242 in response to real-time traffic, automatic or user generated indicators, flags, or alerts, or in response to other automatic or manual selections.

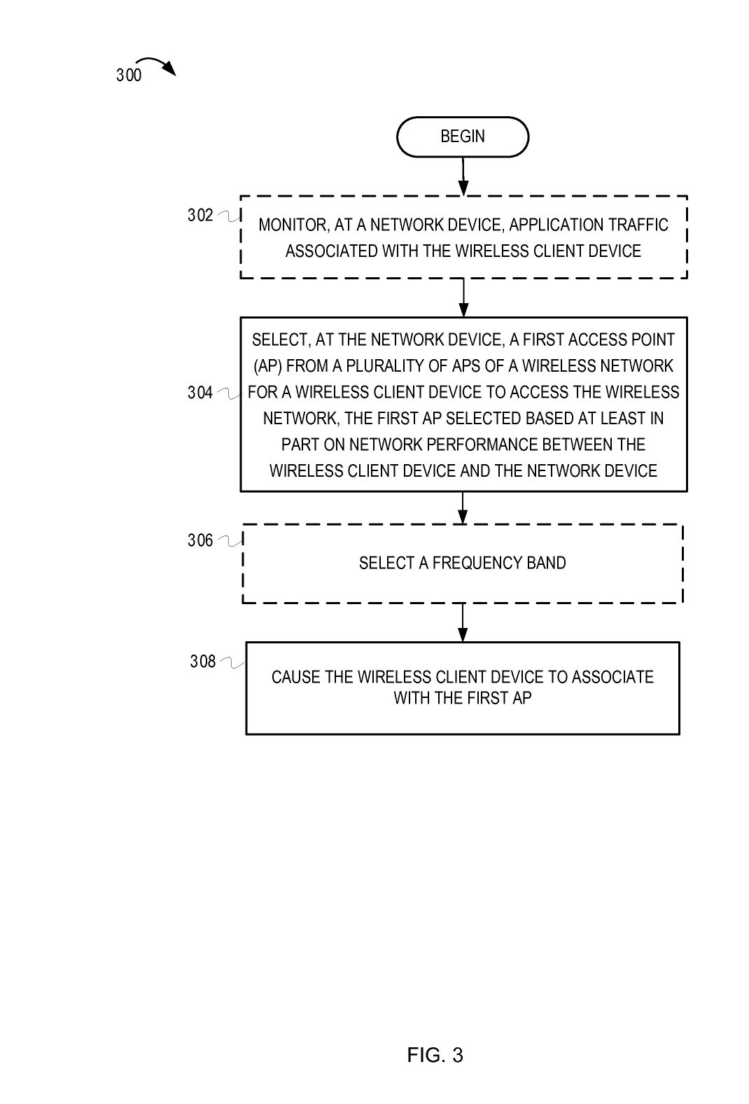

FIG. 3 illustrates a flow diagram 300 of example operations of a network device, such as a CAP or router. In other embodiments, the operations of FIG. 3 may be performed by a remote network device outside of a wireless network associated with a wireless client device.

At block 302, the network device may monitor application traffic associated with the wireless client device. In other embodiments, the network device may monitor traffic associated with multiple wireless client devices. The monitored data may also be utilized to form a historical profile for each of the wireless client devices for predicting future network utilization and trends that may affect how wireless client devices are associated with distinct APs. For example, the network device may record actions of specific users/wireless client devices, time of day, types of content, intensity, and so forth to establish patterns based on previous utilization.

At block 304, the network device may select a first access point (AP) from a plurality of APs of a wireless network for a wireless client device to access the wireless network, the first AP selected based at least in part on network performance between the wireless client device and the network device.

At block 306, the network device may select a frequency band. In one example, selection of the AP in block 304 may include selecting an AP (as well as transceiver) that provides the selected frequency band. In addition, the network device may determine channels being utilized within the frequency band and how the channels may affect performance.

At block 308, the network device may cause the wireless client device to associate with the first AP. The network device may utilize active or passive actions to cause the wireless client device to associate with the first AP. For example, the network device may send a command directly to the wireless client device (or first AP). The network device may also instruct a second AP to block or stop communication with the wireless client device, thus forcing the wireless client device to establish a new connection with the first AP.

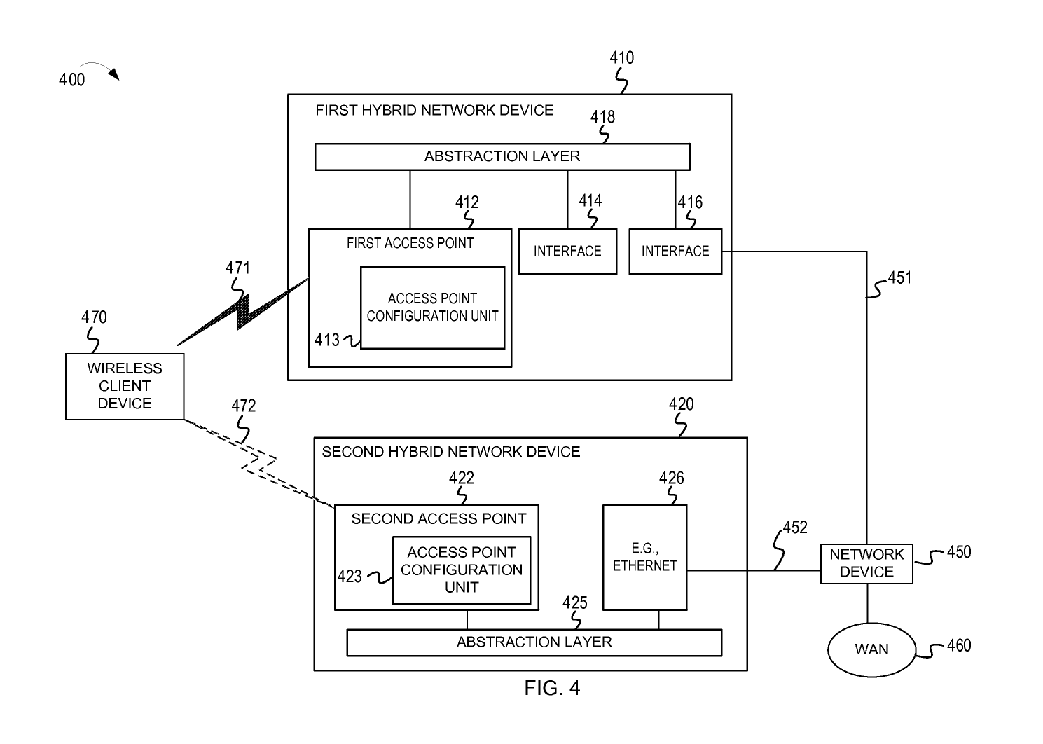

FIG. 4 depicts an example system diagram illustrating a wireless client device associated with a first AP of a hybrid network based on backhaul conditions. Hybrid communication networks comprise multiple networking technologies (e.g., wireless local area network (WLAN) technologies, powerline communication technologies, Ethernet, etc.) that may be interconnected using bridging-capable devices that forward packets between devices utilizing the different network technologies and media in order to form a single extended communication network. For example, in a hybrid communication network, each hybrid device may support multiple layer 2 interfaces using different access technologies (e.g., Ethernet, Wi-Fi, Coax, and Powerline) which can lead to varying conditions in the backhaul. Powerline communication (PLC) networks and Wi-Fi networks may be susceptible to noise from the environment, which may alter performance characteristics associated with a communication connection.

FIG. 4 includes a hybrid network 400 having a first hybrid network device 410, a second hybrid network device 420, and a wireless client device 470. The first hybrid network device 410 may include an abstraction layer 418 associated with multiple types of network interfaces (such as first AP 412, and network interfaces 414, 416). For example, the first AP 412, and network interfaces 414, 416 may represent a WLAN interface (via a first AP 412), an Ethernet interface (via network interface 414), and a powerline interface (via network interface 416). In addition, any number of other interfaces and technologies could be used. The present disclosure is not limited to a particular backhaul technology. Examples of backhaul technologies might include, without limitation, a powerline communication network (as shown in FIG. 4), a multimedia over coax (MoCA, not shown), a fiber optic connection, another wireless link (short range or long range, not shown), or any other technology to communicatively couple the first hybrid network device 410 to a network device 450 (such as a CAP or router).

In the example depicted in FIG. 4, the network interface 416 may communicatively couple the first hybrid network device 410 via a powerline network 451 (or other network) to the network device 450. The network interface 416 and the network interface 414 may provide separate backhaul links to the network device 450. In the example of FIG. 4, the network device 450 may provide centralized coordination for one or more APs in the hybrid network.

The second hybrid network device 420 may include an abstraction layer 425 associated with multiple types of network interfaces including a WLAN interface via a second AP 422, and an Ethernet interface 426 (as a non-limiting example). The Ethernet interface 426 may communicatively couple the second hybrid network device 420 to a LAN 452. The first AP 412 and the second AP 422 can provide wireless connectivity to the wireless client device 470 in the hybrid network 400. The first AP 412 and the second AP 422 include AP configuration units 413 and 423, respectively which may configure the first AP 412 and the second AP 422 based on instructions from the network device 450 to cause the wireless client device 470 to associate with the first AP 412.

In some implementations, the hybrid network devices 410, 420 may be communicatively coupled to the network device 450 via multiple backhaul links. For example, the first hybrid network device 410 may be communicatively coupled to the network device 450 via a backhaul link (e.g., powerline network 451) using the network interface 416. The first hybrid network device 410 may also be communicatively coupled to the network device 450 using the network interface 414 via a LAN (not shown). Similarly, the second hybrid network device 420 is communicatively coupled to the network device 450 via a LAN 452 using the Ethernet interface 426. Based on the channel characteristics (e.g., noise, contention on the channel), different backhaul links may offer different data rates to the hybrid network devices 410 and 420. For example, a powerline communication medium is susceptible to noise from neighboring electrical devices. As a result, the backhaul link using the network interface 416 may offer lower data rates to the first hybrid network device 410 as compared to the backhaul link using the Ethernet interface 426. The network device 450 may compare available data rates on the backhaul links of the hybrid network devices 410 and 420 to select which of the first AP 412 and the second AP 422 the wireless client device 470 should use.

For example, the network device 450 may determine that the first AP 412 using the backhaul link via the network interface 416 offers a first throughput (e.g., 48 Mbps) to the wireless client device 470, while the second AP 422 offers a second throughput (e.g., 10 Mbps) to the wireless client device 470 using the backhaul link via the Ethernet interface 426. The network device 450 can select the first AP 412 so that the wireless client device 470 may benefit from the first throughput that is higher than the second throughput. Based on the throughput, the network device 450 may direct the wireless client device 470 to the first AP 412 (via first potential wireless association 471) rather than the second AP 422 (via second potential wireless association 472). In another embodiment, the first AP 412 and second AP 422 may have multiple backhaul links. Each of the links may be analyzed to determine which AP to select for the wireless client device 470.

In another example, the first AP 412 and the second AP 422 may offer roughly the same or similar throughput, but may have different network paths or network latency. The network device 450 may direct the wireless client device 470 to the first AP 412 (via first potential wireless association 471) rather than the second AP 422 (via second potential wireless association 472) based on reducing the number of hops in path from each of the APs 412, 422 to a destination (e.g., WAN 460). In another example, the AP configuration unit 413 may determine that the network interface 416 is more susceptible to noise due to electrical devices neighboring the first hybrid network device 410 which may result in greater bit error rates to the wireless client device when the wireless client device 470 uses the first AP 412. Based on types of backhaul networks or conditions, the AP configuration unit 413 may select between the first AP 412 and the second AP 422. Other network conditions (sensed or analyzed) and load balancing policies, procedures, or parameters may also be utilized by the AP configuration unit 413. For example, a load balancing procedure may request that the wireless client device 470 transition from the first AP 412 to the second AP point 422 based on new or existing traffic and connections between the first AP 412 and a number of other wireless client devices (not shown).

FIGS. 1-4 and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

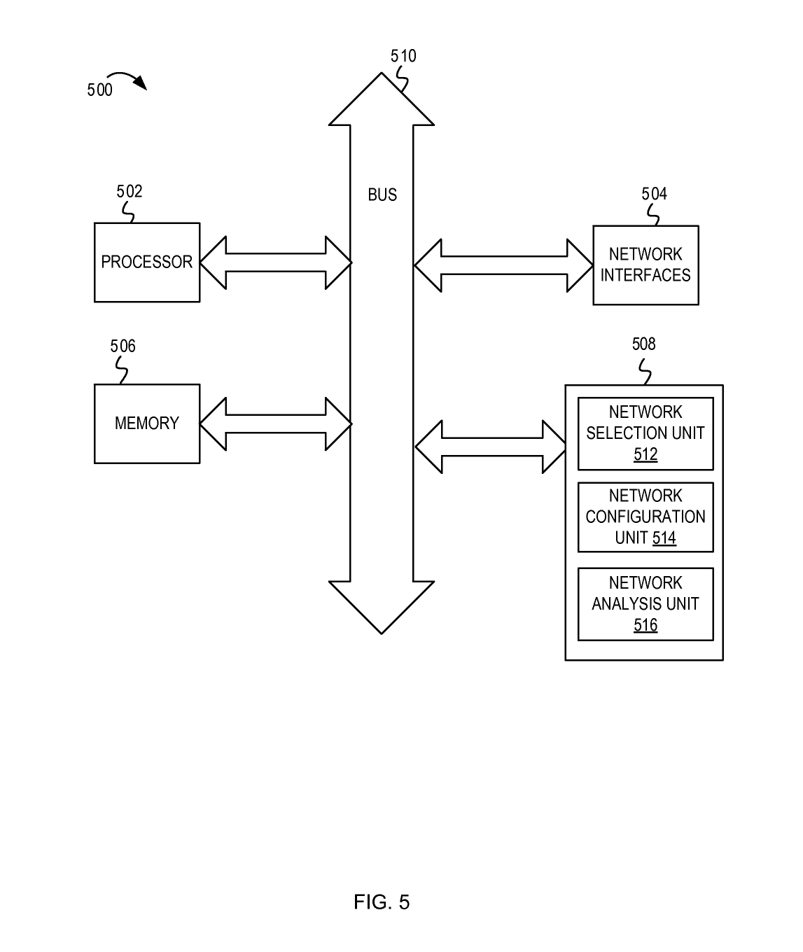

FIG. 5 is an example block diagram of one embodiment of an electronic device 500 capable of implementing various embodiments in accordance with this disclosure. For example, the electronic device may be a network device 150, 450, CAP 204, an AP 110, 120, 412, 422, or an RE 206-210. The electronic device 500 includes a processor 502 (possibly including multiple processors, multiple cores, multiple nodes, and/or implementing multi-threading, etc.). The electronic device 500 includes a memory 506. The memory 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 500 also includes a bus 510 (e.g., PCI, ISA, PCI-Express, HyperTransport®, InfiniBand®, NuBus, AHB, AXI, etc.), and network interfaces 504 that include at least one of a wireless network interface (e.g., a WLAN interface, a Bluetooth® interface, a WiMAX interface, a ZigBee® interface, a Wireless USB interface, etc.) and a wired network interface (e.g., a powerline communication interface, an Ethernet interface, etc.).

The electronic device 500 may include an AP management unit 508. The AP management unit 508 may be capable of performing various methods, techniques, operations, etc. described herein. For example, the AP management unit 508 may be suitable for managing configurations of one or more APs in a wireless network to cause a wireless client device to associate with a particular AP in accordance with embodiments of this disclosure. Any one of these functionalities may be partially (or entirely) implemented in hardware and/or on the processor 502. For example, the functionality may be implemented with an application specific integrated circuit, in logic implemented in the processor 502, in a co-processor on a peripheral device or card, etc. Further, realizations may include fewer or additional components not illustrated in FIG. 5 (e.g., video cards, audio cards, additional network interfaces, peripheral devices, etc.). The processor 502, the memory 506, and the network interfaces 504 are coupled to the bus 510. Although illustrated as being coupled to the bus 510, the memory 506 may be coupled to the processor 502.

The AP management unit 508 can include a network selection unit 512, a network configuration unit 514, and network analysis unit 516. The network analysis unit 516 can determine channel conditions, application traffic, backhaul links, and network performance information. The network selection unit 512 may select a desired AP for a wireless client device to utilize. The network configuration unit 514 can configure the APs to cause the wireless client device to utilize the AP selected by the network device. The network configuration unit 514 may perform this process for numerous wireless client devices and APs to maximize individual and collective performance.

While the embodiments are described with reference to various implementations and exploitations, these embodiments are illustrative and the scope of the present disclosure is not limited to them. In general, techniques for directing association of a wireless client device to a selected first AP as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the present disclosure.

What is claimed is:

1. A method comprising:
selecting, at a network device, a first access point (AP) from a plurality of APs of a wireless network for a wireless client device to access the wireless network, the first AP selected based at least in part on network performance between the wireless client device and the network device; and
causing the wireless client device to associate with the first AP.

2. The method of claim 1, wherein selecting the first AP from the plurality of APs comprises selecting a frequency band.

3. The method of claim 2, wherein selecting the frequency band comprises:
selecting between a plurality of frequency bands available to the wireless client device.

4. The method of claim 2, wherein selecting the frequency band comprises selecting the frequency band based at least in part on wireless capabilities of the wireless client device.

5. The method of claim 2, wherein selecting the frequency band comprises selecting a channel within the frequency band.

6. The method of claim 1, wherein said selecting is performed by a central access point or a router of the wireless network.

7. The method of claim 1, wherein causing the wireless client device to associate with the first AP comprises configuring a second AP in communication with the wireless client device to block at least one incoming packet from the wireless client device to cause the wireless client device to perform a new network discovery and selection.

8. The method of claim 1, wherein causing the wireless client device to associate with the first AP comprises:
instructing a second AP communicating with the wireless client device to disassociate with the wireless client device; and
causing the second AP to refrain from re-associating with the wireless client device for at least one association attempt by the wireless client device or for a period of time.

9. The method of claim 8, further comprising, after causing the second AP to refrain from re-associating with the wireless client device:
causing the second AP to allow a new association from the wireless client device in response to determining that the wireless client device is unable to associate with the first AP.

10. The method of claim 1, wherein selecting the first AP includes:
determining a first performance characteristic related to a first wireless association between the wireless client device and the first AP;
estimating a second performance characteristic related to a second wireless association between the wireless client device and a second AP; and
determining that the first performance characteristic is better than the second performance characteristic.

11. The method of claim 1, wherein selecting the first AP includes:
determining that an association of the wireless client device with the first AP provides at least one of higher throughput, higher quality of service, lower latency, or less jitter for communication with the wireless client device.

12. The method of claim 1, wherein selecting the first AP includes:
determining that an association of the wireless client device with the first AP improves load balancing among the plurality of APs.

13. The method of claim 1, further comprising:
monitoring, at a central access point or router, traffic associated with the wireless client device; and
selecting the first AP to improve performance associated with the traffic.

14. The method of claim 1, wherein selecting the first AP comprises:
selecting the first AP based at least in part on one or more backhaul networks utilized by the plurality of APs.

15. The method of claim 1, wherein selecting the first AP is performed to enhance performance of the wireless network even if performance of one or more of the plurality of APs decreases.

16. The method of claim 1, wherein selecting the first AP comprises:
analyzing communication history for the plurality of APs to select the first AP.

17. The method of claim 1, further comprising:
steering a plurality of wireless client devices utilizing the wireless network to associate with one of the plurality of APs.

18. A network device, comprising:
a processor; and
memory for storing instructions which, when executed by the processor, causes the network device to:
select a first access point (AP) from a plurality of APs of a wireless network for a wireless client device to access the wireless network, the first AP selected based at least in part on network performance between the wireless client device and the network device; and
cause the wireless client device to associate with the first AP.

19. The network device of claim 18, wherein the instructions, when executed by the processor, further causes the network device to modify a configuration of a second AP to block at least one incoming packet from the wireless client device to force the wireless client device to perform a new network discovery and selection.

20. The network device of claim 18, wherein the instructions, when executed by the processor, further causes the network device to:
monitor for traffic associated with the wireless client device, and
select the first AP to improve performance associated with the traffic.

21. The network device of claim 18, wherein the network device comprises a central access point or router of the wireless network in communication with the plurality of APs.

22. The network device of claim 18, wherein the instructions, when executed by the processor, further causes the network device to select the first AP based at least in part on one or more backhaul networks utilized by the plurality of APs.

23. The network device of claim 18, wherein the instructions, when executed by the processor, further causes the network device to utilize a communication history for the plurality of APs to select the first AP.

24. A non-transitory computer readable medium for storing instructions which, when executed by one or more processors of a device, cause the device to perform operations comprising:
selecting, at a network device, a first access point (AP) from a plurality of APs of a wireless network for a wireless client device to access the wireless network, the first AP selected based at least in part on network performance between the wireless client device and the network device; and
causing the wireless client device to associate with the first AP.

25. The non-transitory computer readable medium of claim 24, wherein the operations causing the wireless client device to associate with the first AP further comprise configuring a second AP in communication with the wireless client device to block at least one incoming packet from the wireless client device to force the wireless client device to perform a new network discovery and selection.

26. The non-transitory computer readable medium of claim 24, wherein the network device comprises a central access point or router of the wireless network in communication with the plurality of APs.

27. The non-transitory computer readable medium of claim 24, wherein the operations for selecting the first AP are based at least in part on one or more backhaul networks utilized by the plurality of APs.

28. The non-transitory computer readable medium of claim 24, wherein the operations further comprise steering the wireless client device utilizing the wireless network to associate with one of the plurality of APs.

29. An apparatus comprising:
means for selecting, at a network device, a first access point (AP) from a plurality of APs of a wireless network for a wireless client device to access the wireless network, the first AP selected based at least in part on network performance between the wireless client device and the network device; and
means for causing the wireless client device to associate with the first AP.

30. The apparatus of claim 29, wherein the means for causing the wireless client device to associate with the first AP comprise means for configuring a second AP in communication with the wireless client device to block at least one incoming packet from the wireless client device to force the wireless client device to perform a new network discovery and selection.
